(19) United States
(12) Patent Application Publication
(10) Pub. No.: US 2026/0343478 A1
(43) Pub. Date: Oct. 29, 2026

(54) SYSTEM FOR DETERMINING THE LOCATION OF A SENSOR OR ACTUATOR WITHIN AN INDUSTRIAL INSTALLATION

(71) Applicant: ifm electronic gmbh, Essen (DE)

(72) Inventor: Manfred Krämer, Berg (DE)

(73) Assignee: ifm electronic gmbh, Essen (DE)

(21) Appl. No.: 19/655,876

(22) Filed: Apr. 23, 2026

(30) Foreign Application Priority Data
Apr. 28, 2025 (DE) 102025116136.4

(51) Int. Cl. H04W 64/00

(52) U.S. Cl. CPC H04W 64/00

(57) ABSTRACT

The system according to the invention determines the location of a sensor or actuator in an industrial installation in that a mobile device detects the location thereof without the sensor or actuator having its own positioning system and transmits the location to a higher-level system. The mobile device transmits the location data wirelessly to the sensor or actuator, which stores the location data and forwards the location data to the higher-level system. As a result, a cost-effective and energy-efficient location determination is made possible.

The present invention relates to a system for determining the location of a sensor or actuator, in particular for use in an industrial installation.

In modern industry, increasingly networked sensors and actuators are used to monitor and control production processes. These devices provide valuable data that contribute to optimizing the efficiency and safety of installations. In particular in large industrial installations, these sensors and actuators are often distributed over wide areas, which makes management and localization of individual devices more difficult.

An obvious solution for determining the location of devices consists in equipping each device with its own GPS module. However, this solution is associated with several disadvantages. On the one hand, GPS modules increase the costs and energy consumption of the devices. On the other hand, GPS signals are often difficult or impossible to receive indoors or in densely built industrial installations, which impairs the accuracy of the location determination. A further disadvantage is that GPS modules increase the structural size of the device.

Another obvious solution consists in manually locating the devices and detecting their locations in a central system. However, this solution is time-consuming, prone to errors and labor intensive.

A disadvantage of these solutions is that the devices themselves must have complex functionality in order to determine and transmit their position. This increases the complexity of the devices and thus also the probability of malfunctions.

In the previously unpublished application 102024118005.6 of the applicant, the interaction of a sensor with a mobile communication device is described, in which as many tasks and computing processes as possible in the configuration for a mobile communication are outsourced to a mobile communication device, e.g., a smartphone, and subsequently a finished configuration of the mobile communication connection that is optimal on site is transmitted very energy-efficiently, preferably via an NFC or Bluetooth data connection, to the sensor.

The object is to provide an improved system for determining the location of sensors and actuators in industrial installations, which avoids the aforementioned disadvantages and makes a simple, cost-effective and reliable localization of the devices possible.

The object is achieved according to the invention by a system having the features of claim 1. Advantageous embodiments of the invention are specified in the dependent claims.

According to the invention, a system for determining the location of a sensor or actuator within an industrial installation comprises: a mobile device with a positioning system and a first wireless communication interface; the sensor or actuator, wherein the sensor or actuator lacks an integrated positioning system; and a second wireless communication interface at the sensor or actuator, which is configured to: receive location data from the mobile device, wherein the location data are detected by the positioning system of the mobile device if the mobile device is located in the vicinity of the sensor or actuator; store the location data; and transmit the location data to a higher-level system. This makes a cost-effective and energy-efficient location tracking of devices within an industrial installation possible, without each device having to have its own positioning system.

According to a preferred embodiment of the invention, the wireless communication interface is based on the Bluetooth, NFC or WiFi standard. This provides flexible and widely used options for wireless short-range communication between the mobile device and the sensor or actuator.

According to a preferred embodiment of the invention, the mobile device is a smartphone. This utilizes the widespread availability and computing power of smartphones for the simple and convenient detection of location data.

According to a preferred embodiment of the invention, the higher-level system is a PLC. This makes a seamless integration into existing industrial control systems possible for real-time monitoring and control.

According to a preferred embodiment of the invention, the positioning system of the mobile device comprises a GPS module. This utilizes a generally available and accurate positioning technology for reliable location data.

According to a preferred embodiment of the invention, the location data comprise geographic longitude and latitude coordinates. This provides precise and standardized location information for accurate mapping and tracking.

According to a preferred embodiment of the invention, the wireless communication interface of the sensor or actuator automatically transmits the location data to the higher-level system as soon as the location data have been received from the mobile device and stored. This makes real-time location updates possible for improved monitoring and response capabilities.

According to a preferred embodiment of the invention, the sensor is a device for detecting pressure, temperature, flow, throughput, fill levels, an optical, capacitive or inductive proximity switch or sensor or a vibration monitoring device. This makes the location tracking of various sensors used for monitoring critical parameters in industrial processes possible.

According to a preferred embodiment of the invention, the actuator is a valve, an actuator motor, a switch, a relay or a pump. This makes the location tracking of various actuators used for controlling industrial processes possible.

According to a preferred embodiment of the invention, the sensor or actuator is connected to the higher-level system via a fieldbus. This ensures reliable and standardized data transmission between the sensor/actuator and the control system.

The invention is explained in more detail below with the aid of exemplary embodiments while making reference to the drawings.

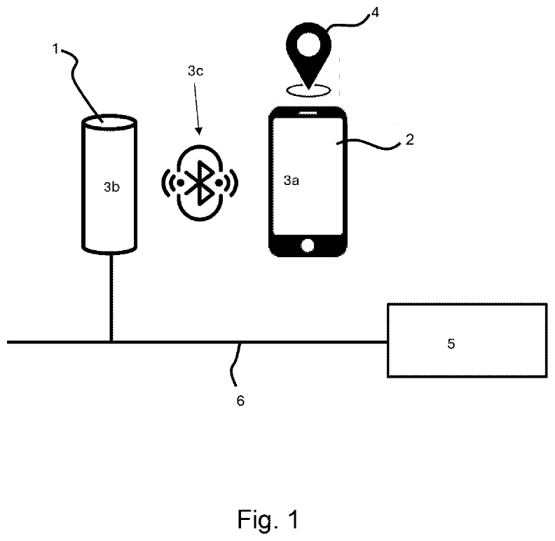

FIG. 1 shows a schematic representation of a system for determining the location of a sensor 1 or actuator within an industrial installation. The system comprises the sensor 1 or actuator, a mobile device 2, a higher-level system 5 in the form of a PLC and a wireless communication connection 3c.

The sensor 1 or actuator is a device that is used in an industrial installation in order to detect or influence certain physical or chemical variables. Examples of sensors are pressure sensors, temperature sensors, flow sensors, fill level sensors, optical proximity switches, capacitive proximity sensors, inductive proximity sensors and vibration monitors. Examples of actuators are valves, actuator motors, switches, relays and pumps.

The sensor 1 or actuator lacks an integrated positioning system, such as a GPS module, in order to save costs and energy. Instead, the location of the sensor 1 or actuator is determined via the mobile device 2.

The mobile device 2 is preferably a smartphone or tablet computer, which comprises a positioning system 4, such as a GPS module, and a wireless communication interface 3a. The mobile device 2 is configured to detect its current location data and to transmit the location data wirelessly to the sensor 1 or actuator.

The mobile device 2 approaches the sensor 1 or actuator, so that the location data of the mobile device 2 correspond to the location of the sensor 1 or actuator. After the approach, the mobile device 2 transmits its location data wirelessly to the sensor 1 or actuator. For this purpose, the sensor 1 or actuator likewise has a wireless communication interface 3b.

The wireless communication connection 3c between the sensor 1 or actuator and the mobile device 2 is preferably based on a standard such as Bluetooth, NFC or WiFi. These standards make a simple and cost-effective data transmission over short distances possible.

The sensor 1 or actuator stores the received location data in a memory unit. The location data preferably comprise geographic longitude and latitude coordinates.

The wireless communication interface 3b of the sensor 1 or actuator automatically transmits the location data to the higher-level system 5 as soon as the location data have been received from the mobile device 2 and stored.

The higher-level system 5 is preferably a programmable logic controller (PLC), which manages the location data of the sensors 1 and actuators and is used for controlling the installation.

The sensor 1 or actuator is connected to the higher-level system 5 via a fieldbus 6. The fieldbus 6 makes a reliable and standardized data transmission between the sensor 1 or actuator and the higher-level system 5 possible.

The location symbol is shown in the drawing in order to illustrate that the mobile device 2 detects the location of the sensor 1 if the mobile device 2 is located in the immediate vicinity of the sensor 1.

The system according to the invention makes a simple, cost-effective and reliable localization of sensors 1 and actuators in industrial installations possible. Since the sensors 1 and actuators do not themselves have to have their own positioning system, costs and energy can be saved. By using a mobile device 2 for location determination, locations can also be detected indoors or in densely built industrial installations in which GPS signals are difficult to receive.

### LIST OF REFERENCE SIGNS

1 Sensor or actuator
2 Mobile device, smartphone
3a Wireless communication interface
3b Wireless communication interface
3c Wireless communication connection
4 Positioning system
5 Higher-level system, PLC
6 Fieldbus

1. A system for determining the location of a sensor or actuator within an industrial installation, comprising:
a mobile device with a positioning system and a first wireless communication interface;
the sensor or actuator, wherein the sensor or actuator lacks an integrated positioning system; and
a second wireless communication interface at the sensor or actuator, which is configured to:
receive location data from the mobile device, wherein the location data is detected by the positioning system of the mobile device if the mobile device is located in the vicinity of the sensor or actuator;
store the location data; and
transmit the location data to a higher-level system.

2. The system according to claim 1, wherein the wireless communication interface is based on the Bluetooth, NFC or WiFi standard.

3. The system according to claim 1, wherein the mobile device is a smartphone.

4. The system according to claim 1, wherein the higher-level system is a PLC.

5. The system according to claim 1, wherein the positioning system of the mobile device comprises a GPS module.

6. The system according to claim 1, wherein the location data comprises geographic longitude and latitude coordinates.

7. The system according to claim 1, wherein the wireless communication interface of the sensor or actuator automatically transmits the location data to the higher-level system as soon as the location data have been received from the mobile device and stored.

8. The system according to claim 1, wherein the sensor is a device for detecting pressure, temperature, flow, throughput, fill levels, an optical, capacitive or inductive proximity switch or sensor or a vibration monitoring device.

9. The system according to claim 1, wherein the actuator is a valve, an actuator motor, a switch, a relay or a pump.

10. The system according to claim 1, wherein the sensor or actuator is connected to the higher-level system via a fieldbus.
